(19) United States
(12) Patent Application Publication
(10) Pub. No.: US 2022/0057808 A1
(43) Pub. Date: Feb. 24, 2022

(54) INSPECTION VEHICLE

(71) Applicant: Commonwealth Scientific and Industrial Research Organisation, Acton (AU)

(72) Inventors: James Brett, Acton (AU); Paul Flick, Acton (AU); Erin Mccoll, Acton (AU)

(21) Appl. No.: 17/415,524

(22) PCT Filed: May 1, 2020
(86) PCT No.: PCT/AU2020/050437

§ 371 Date: Jun. 17, 2021

(30) Foreign Application Priority Data
May 2, 2019 (AU) 2019901492

(51) Int. Cl. G05D 1/02; B62D 55/06; B65G 1/04

(52) U.S. Cl. CPC G05D 1/0276; G05D 2201/0207; B65G 1/0492; B62D 55/06

(57) ABSTRACT

The present invention relates to an inspection vehicle configured to inspect a confined space. The inspection vehicle includes an elongate rigid body including a planar upper surface and drive modules along either side of the body. Each drive module includes an endless track, an upper surface of the endless tracks is positioned below a height of the planar upper surface so that the planar upper surface engages an obstacle in preference to the endless tracks; front ones of the endless tracks project forwardly of the body so that the front endless tracks engage an obstacle in preference to the body; sensors around the inspection vehicle to sense the confined space; a communications module to provide sensor data to remote processing systems; and receive control signals; processing devices to control the drive modules to allow the inspection vehicle to traverse the confined space.

### BACKGROUND OF THE INVENTION

The present invention relates to an inspection vehicle, in one particular example, an inspection vehicle for inspecting a confined space.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Generally, inspection systems are used in factories to monitor an environmental condition. Cameras or sensors mounted on carts are known to be used to carry out inspections in the factories. The carts move between stacks of pallets and monitor the factory environment. However, the cart is generally restricted by its size and unable to travel under/through the pallets to conduct inspection in the confined space.

U.S. Pat. No. 6,889,783 relates to a remote controlled inspection vehicle provides interchangeable modules, permitting the vehicle to be easily configured to perform a wide variety of tasks. The vehicle includes at least one frame module having a pair of drive modules on either side. Each drive module includes a continuous track surrounding a permanent magnet, and is dimensioned and configured to pivot around its longitudinal axis. The frame modules are dimensioned and configured to be hingedly secured to other frame modules, end effectors including various sensors for performing inspections, and tail units to assist in placing the vehicle in the desired environment.

US20180059187 relates to a modular device is used to inspect a confined space in a machine. The entire inspection coverage area and corresponding status are mapped so that the inspection location and associated data are graphically visualized. An accelerometer mounted on the device serves as a tilt sensor and also provides data about a collision of the device with the space being inspected or defects therein. The accelerometer data in combination with an odometry system determines the axial position of the device. A gyroscope mounted on the device is used to determine the device heading. The locational information is used to generate an inspection map that provides inspection history, logged data and a reference that are useful in scheduling the next inspection. The output of the gyroscopes can be used to provide haptic feedback to the device operator to maintain proper device orientation.

WO2017220716 discloses a method of processing depth data and image data from a robotic device having a camera and a depth measurement device mounted to a chassis of the robotic device to generate a data set representative of a three-dimensional map of an environment in which the robotic device is located. The camera is arranged to generate image data relating to the environment. The depth measurement device is arranged to generate depth data relating to the environment. The method comprises generating image data and depth data at a first location of the robotic device in the environment, whereby to generate a first data set comprising a plurality of data points. The method further comprises moving the robotic device to at least a second location in the environment. The method further comprises generating image data and depth data at the second location, whereby to generate a second data set comprising a plurality of data points. The method further comprises associating each data point of the first data set with the spatially nearest point of the second data set, if any, within a predefined distance from the first data point. The method further comprises replacing data points from the first data set with the associated data points from the second data set by reference to the distance of the data point from the location of the robotic device when the data point was generated.

U.S. Pat. No. 5,435,405 relates to a mobile vehicle having at least one endless driven member for driving the endless member on a surface capable of supporting a magnetic circuit. The vehicle is equipped with a magnetic system that is housed in a substantially hermetically sealed enclosure and comprises a magnet, a fixed magnetic circuit member, and a movable magnetic circuit member for establishing first and second magnetic circuits. A clutch is provided to selectively connect the movable magnetic circuit member to the motor to move the movable magnetic circuit member between a first position wherein the first magnetic circuit is established such that the endless driven member can magnetically engage the surface and a second position wherein the second magnetic circuit is established such that the endless member does not magnetically engage the surface. The enclosure is pressurized with a pressure medium at a predetermined pressure and temperature and is monitored by sensors within the enclosure. The pressure and temperature sensors interface with microprocessors which can trigger a shut down of the vehicle's components should anomalous pressure or temperature conditions occur within the enclosure. The vehicle also has permanent magnet tracks pivotally attached thereto to enable the vehicle to traverse between intersecting magnetic wall surfaces.

DE3811795 relates to a device for the remote-controllable inspection and/or for the remote-controllable operation in areas which due to their spatial conditions and/or their safety requirements are inaccessible for people, has a self-propelling assembly made of at least two vehicles, an inspection and/or processing device and a control device for the spatial change in the direction of movement of the assembly, the individual vehicles being connected via longitudinally stiff swivelling joints and the direction of movement of the assembly being controlled by remote-controlled Bowden cables. The inspection and/or processing device can be swivelled independently of the vehicle control, likewise by a Bowden cable and a separate rotary actuator. The device is enormously significant, is able to overcome obstacles which are clearly higher than the intrinsic height of that vehicle, can be used extremely economically and can also operate automatically for all essential operations and be controlled remotely without being connected to a remote-control cable.

JP6370512 relates to an endless track traveling device of the generator inspection robot. In the position of the traveling object side of the virtual straight line connecting the first vertex of the at traveling object side to the outer peripheral surface of the outer peripheral surface and the apex of the in the traveling object side second pulley of the pulley, the endless track toward the plate-shaped member having a planar portion that contacts the inner peripheral surface.

ES2348074 relates to a cell inspection and repair automated pallet, in which a pallet inspected are transported to one or more posts from a position of automated inspection, and a fastener is used of pallets for moving pallets, characterized in that the post or posts are posts for repair of pallets, that the holding pallet is fastened to an arm of a robot multiple axes because the position inspection is operative to draw a map of three-dimensional data of a surface of pallet inspected because a processor interprets the map and produces a recipe for the robot, and that the robot is capable of gripping the pallet and transporting it to one or more of the posts as prescribed repair.

The above-described devices have various limitations which make them unsuitable for use in pallet inspections.

### SUMMARY OF THE PRESENT INVENTION

In one broad form an aspect of the present invention seeks to provide an inspection vehicle configured to inspect a confined space, the inspection vehicle including an elongate substantially rigid body including a substantially planar upper surface; a number of drive modules positioned along either side of the body, each drive module including an endless track supported by drive wheels and driven by at least one motor, the endless tracks being configured to engage a surface and propel the vehicle, and wherein an upper surface of the endless tracks is positioned below a height of the planar upper surface so that the planar upper surface engages an obstacle in preference to the endless tracks; front ones of the endless tracks project forwardly of the body so that the front endless tracks engage an obstacle in preference to the body; a plurality of sensors disposed around the inspection vehicle to sense the confined space; a communications module configured to provide sensor data to one or more remote processing systems; and, receive control signals one or more remote processing systems; one or more processing devices configured to control the drive modules in accordance with the control signals to allow the inspection vehicle to traverse the confined space.

In one embodiment, the inspection vehicle includes a communications tether that interconnects the communications module and the one or more remote processing systems.

In one embodiment, the tether is used to provide power to the inspection vehicle.

In one embodiment, the tether is configured to resist tensional forces, and thereby allowing the inspection vehicle to be retrieved by pulling on the tether.

In one embodiment, the sensors include at least one of image sensors; thermal image sensors; and, range sensors.

In one embodiment, the sensors include a front sensor position on a front of the body; a rear sensor position on a rear of the body; and, side sensors positioned on each side of the body.

In one embodiment, the one or more processing devices are configured to at least partially process signals from the sensor; and, generate the sensor data.

In one embodiment, the one or more remote processing systems are configured to display a representation of the confined space using the sensor data; and, generate control signals in accordance with user input commands provided at least in part based on the representation.

In one embodiment, the one or more remote processing systems are configured to use the sensor data to construct a model of the confined space; and, generate a representation of the model.

In one embodiment, the vehicle has at least one of an overall width of about 150 mm; an overall length of about 1220 mm; and, an overall height of about 50 mm.

In one embodiment, the confined space includes a space between upper and bottom deckboards of a pallet.

In one embodiment, the vehicle is configured to span a gap between at least one of bottom deckboards of a pallet; and, adjacent pallets.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:

FIG. 1A is a schematic side view of an example of an inspection vehicle;

FIG. 1B is a schematic front view of the inspection vehicle of FIG. 1;

FIG. 2 is a schematic view of the inspection vehicle of FIG. 1 inspecting in a confined space ; and

FIG. 3 is a schematic diagram of an example of a processing system;

FIG. 4A is a prospective view of an example of an inspection vehicle;

FIG. 4B is an internal prospective view of the inspection vehicle of FIG. 4A;

FIG. 4C is a side view of the inspection vehicle of FIG. 4A; and,

FIG. 4D is a front view of the inspection vehicle of FIG. 4A.

### DETAILED DESCRIPTION OF THE PREFERRED EMBODIMENTS

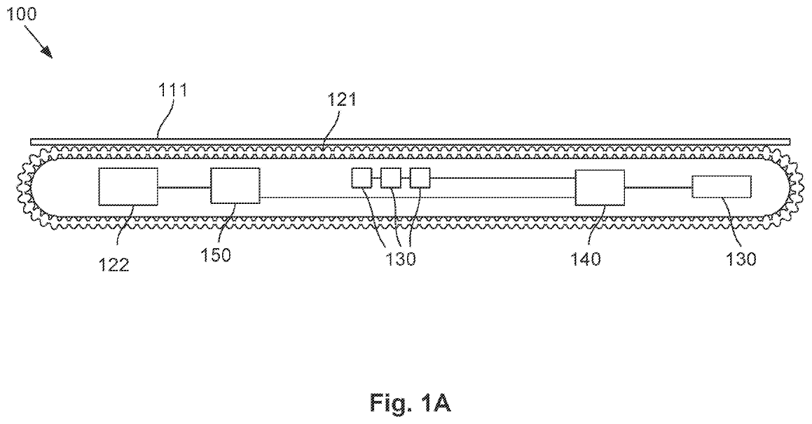

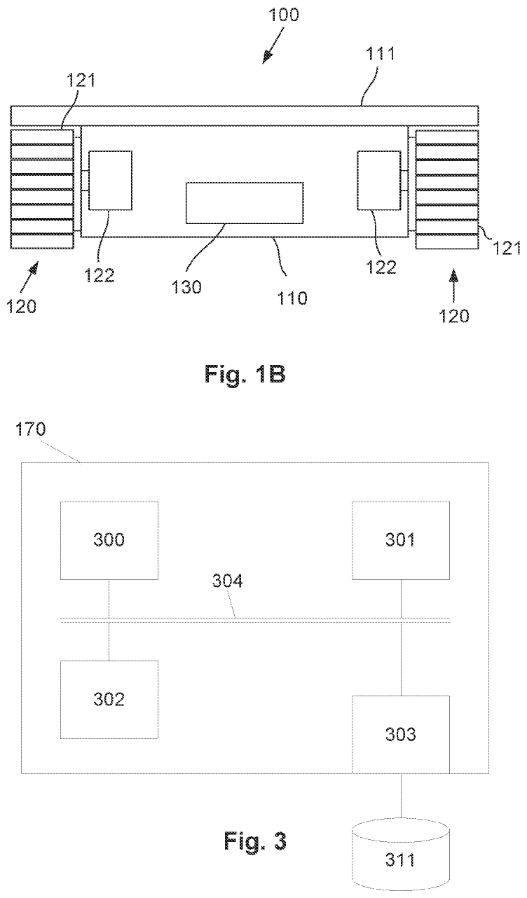

An example of an inspection vehicle for inspecting a confined space will now be described with reference to FIGS. 1A and 1B.

The inspection vehicle 100 includes an elongate body 110, and a number of drive modules 120 positioned along either side of the body 110. The elongate body 110 includes a substantially planar upper surface 111 and is substantially rigid. The elongate body 110 and the substantially planar upper surface 111 may be made of steel, aluminium or other types of alloy suitable. It should also be appreciated that other substantially rigid and robust materials may also be used. The inspection vehicle 100 has a generally slim and narrow profile for travelling in a confined space, such as between pallets in a factory environment. In one example, the inspection vehicle 100 has an overall width of about 150 mm, an overall length of about 1200 mm and an overall height of about 50 mm, although it will be appreciated that these dimensions may vary depending on the intended application, the size and configuration of the confined space being inspected, or the like.

Each drive module 120 includes an endless track 121 supported by drive wheels and driven by at least one motor 122. The endless tracks 121 engage a surface and propel the vehicle 100. An upper surface of the endless tracks 121 is positioned below a height of the planar upper surface 111, so that the planar upper surface 111 engages an obstacle in preference to the endless tracks 121. Additionally, front ones of the endless tracks 121 project forwardly of the body 110, so that the front endless tracks engage an obstacle in preference to the body 110. The endless tracks 121 are typically made of rubber for engaging obstacles or floor surfaces. It should be appreciated that metal or other materials may also be suitable.

The inspection vehicle 100 further includes a plurality of sensors 130, a communications module 140 and one or more processing devices 150. The sensors 130 are disposed around the inspection vehicle 100 to sense the confined space. The sensors 130 may be image sensors, thermal image sensors, and/or range sensors for detecting a condition of the environment, such as misplacement of hazardous materials, fire, etc. The communications module 140 provides sensor data to one or more remote processing systems, and receives control signals from one or more remote processing systems.

The one or more processing devices 150 controls the drive modules 120 in accordance with the control signals to allow the inspection vehicle 100 to traverse the confined space. Accordingly, the one or more processing device 150 may be formed from any suitable processing device that is capable of processing sensor signals, and could include a microprocessor, microchip processor, logic gate configuration, firmware optionally associated with implementing logic such as an FPGA (Field Programmable Gate Array), or any other electronic device, system or arrangement. For ease of illustration, the remaining description will make reference to a processing device, but it will be appreciated that multiple processing devices could be used, with reference to the singular encompassing the plural arrangements and vice versa.

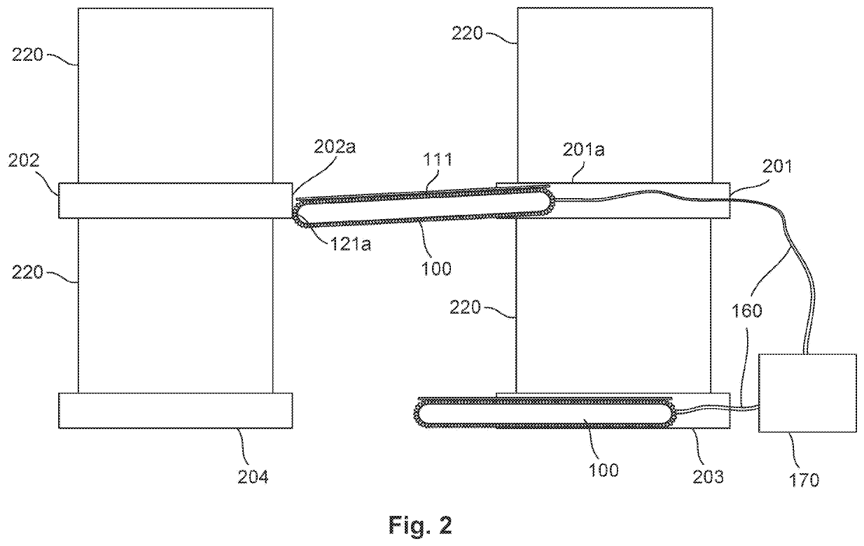

When in use, with reference to FIG. 2, the inspection vehicle 100 inspects in a confined space such as between and/or under pallets 201-204. In one example, the pallets 201-204 with loads 220 are stacked in a factory environment. The inspection vehicle 100 travels between the pallets 201-204 and inspect the confined space with the sensors 130. When the inspection vehicle 100 travels from an elevated pallet 201 to another elevated pallet 202, the inspection vehicle 100 may tilt due to the front portion of the inspection vehicle 100 being unsupported. The inspection vehicle tilts and the planar upper surface 111 engages with an underside surface 201a of a top of the pallet 201 in preference to the endless tracks 121, so that a top portion of the endless tracks is guarded from being in contact with the surface 201a. Front ones 121a of the endless tracks 121 engage with a side surface 202a of the pallet 202 in preference to the body 110.

As described above, the inspection vehicle are of a low-and-narrow form to facilitate movement through, under and between the pallets. The planar upper surface 111 allows the inspection vehicle 100 to travel without being interfered by the movement of the upper portion of the endless tracks 121 when it engages with the underside surface 201a. The front endless tracks 121a protrudes from the body 110 of the inspection vehicle 100 allows the vehicle 100 to lift itself as it engages with the side surface 202a. The drive module 120 are easily removed from the body 110 for quick replacement or configuration.

A number of further features will now be described.

In one example, the inspection vehicle includes a communications tether that interconnects the communications module and the one or more remote processing systems. In the example illustrated in FIG. 2, the communications tether 160 is connected between the communications module 140 and the remote processing system 170. It is advantageous to have the communications tether in an environment where wireless transmission is not permitted or possible, for example due to interference in the environment. In a further example, the tether can be configured to resist tensional forces, and secured to the elongate body 110, thereby allowing users to pull on the tether to retrieve the inspection vehicle in the event it becomes stuck.

Additionally, the tether can be used to provide power to the inspection vehicle. This allows a stable and sufficient power supply is provided to the inspection vehicle, whilst avoiding the need for the vehicle to contain batteries. This helps reduce the overall weight of the vehicle, allows internal space to be used for other electronics, such as sensing systems, and avoids the need for the vehicle to contain hazardous materials, which might be precluded from use in some environments.

The sensors of the inspection vehicle include a front sensor position on a front of the body, a rear sensor position on a rear of the body, and side sensors positioned on each side of the body. This allows the inspection vehicle to sense and detect the environment in various directions, and in one particular example, in 360° around a horizontal plane through the vehicle, which is advantageous in inspecting confined spaces with hard-to-reach corners or gaps. Additionally, as the sensors typically have a field of view extending vertically, this allows sensing to be performed over the entire volume beneath the pallet.

In one example, the one or more processing devices are configured to at least partially process signals from the sensor, and generate the sensor data. This allows sensor data be processed on-board, such as filtering, sampling or encrypting the sensor data, for effective or secured data transmission.

In one example, the one or more remote processing systems are configured to display a representation of the confined space using the sensor data, and generate control signals in accordance with user input commands provided at least in part based on the representation. This allows a user to have a visual representation of the space remotely, for example having this displayed on a screen of the processing system, and controlling the inspection vehicle to move within the environment, for example using suitable inputs provided via a user interface or similar. In one example, the one or more remote processing systems are configured to use the sensor data to construct a model of the confined space, and generate a representation of the model, such as a 3-dimensional map.

It will be appreciated that the nature of the representation will also depend on the nature of the sensors employed. For example, the sensors could include imaging devices, such as cameras, for generating a visual model showing the visible appearance of the region under the pallet. The sensors could include range sensors, such as LIDAR, which could be used to generate a point cloud model of underneath the pallets. Temperature sensors, could be used to generate information regarding temperature distributions under and/or on the pallets, or the like. In a further example, data from multiple sensors could be fused. For example, LIDAR and cameras could be used in conjunction to generate a colourised point cloud, which could then be overlaid with temperature information in order to show temperature variations within a 3D representation of the volume under the pallet. This can be useful for identifying features of interest, such as areas of heat generation within items stored on the pallets. It will also be appreciated that other sensors, such as pressure, humidity, or the like could also be incorporated.

In addition, sensor data could be analysed to performing mapping and/or localisation, for example to track movement of the robot within the environment. In one example, the system can be configured to implement a SLAM (Simultaneous Localisation And Mapping) algorithm in order to generate a model of the environment, and track movement of the inspection vehicle through the environment.

An example of a suitable remote processing system 170 is shown in FIG. 3. In this example, the remote processing system 170 includes an electronic processing device, such as at least one microprocessor 300, a memory 301, an optional input/output device 302, such as a keyboard and/or display, and an external interface 303, interconnected via a bus 304 as shown. In this example the external interface 303 can be utilised for connecting the remote processing system 170 to the processing device 150, and optionally other peripheral devices, communications networks, databases 311, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to perform required processes, such as communicating with other processing devices 150. Thus, actions performed by a processing system 201 are in accordance with instructions stored as applications software in the memory 301 and/or input commands received via the I/O device 302. The applications software may include one or more software modules, and may be executed in a suitable execution environment, such as an operating system environment, or the like.

Accordingly, it will be appreciated that the remote processing systems 170 may be formed from any suitable processing system, such as a suitably programmed computer system, PC, web server, network server, or the like. In one particular example, the remote processing system 170 is a standard processing system such as a 32-bit or 64-bit Intel Architecture based processing system, which executes software applications stored on non-volatile (e.g., hard disk) storage, although this is not essential. However, it will also be understood that the remote processing systems 170 could be or could include any electronic processing device such as a microprocessor, microchip processor, logic gate configuration, firmware optionally associated with implementing logic such as an FPGA (Field Programmable Gate Array), or any other electronic device, system or arrangement.

It will also be noted that whilst each of the processing device 150 and the remote processing system 170 are shown as single entities, it will be appreciated that this is not essential, and instead one or more of the processing systems can be distributed over geographically separate locations, for example by using processing systems provided as part of a cloud based environment.

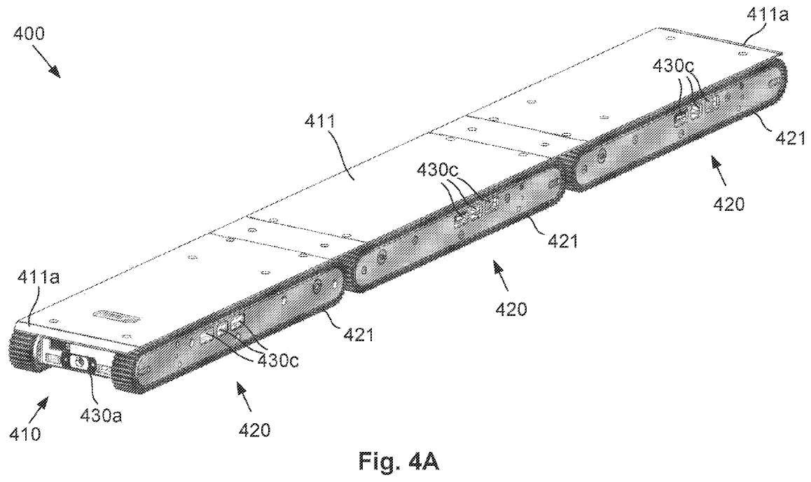

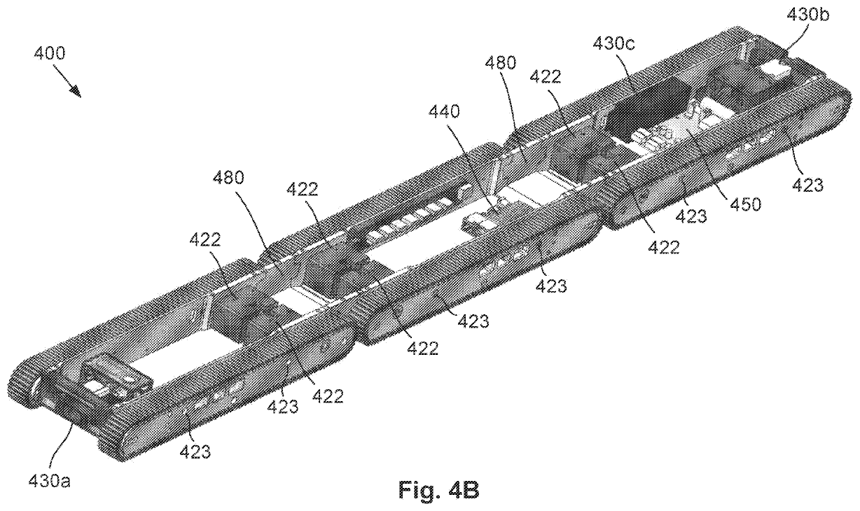

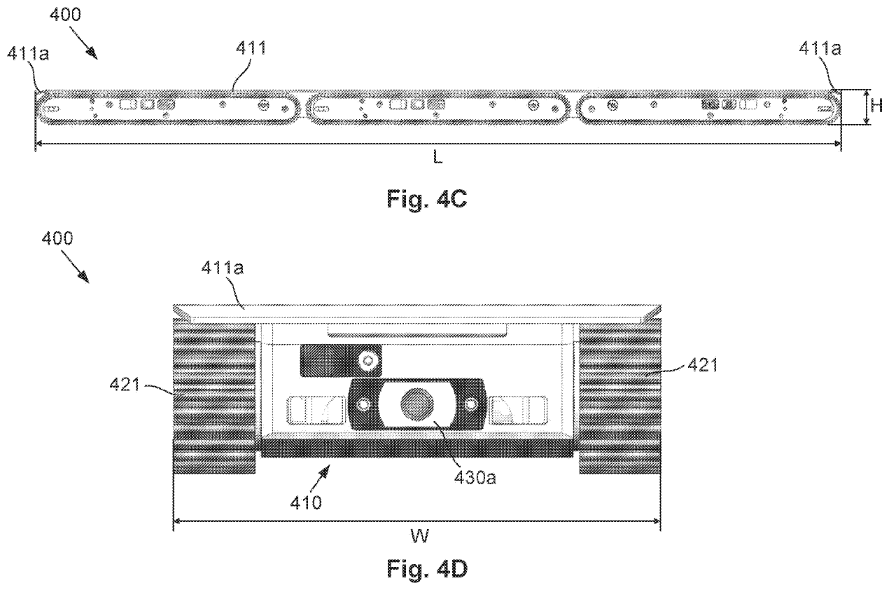

An example of the inspection vehicle for inspecting a confined space will now be described in further detail with reference to FIGS. 4A to 4D.

The inspection vehicle 400 includes an elongate body 410, and three detachable drive modules 420 are positioned along either side of the body 410. The elongate body 410 includes a substantially planar upper surface 411 and is substantially rigid and can be detached to provide access to internal components. The elongate body 410 and the substantially planar upper surface 411 are made of metal, such as aluminium or steel, to provide sufficient robustness. The inspection vehicle 400 has a slim and narrow profile to facilitate moving between pallets in a factory environment. In this example, the inspection vehicle 400 has an overall width (W) of about 150 mm; an overall length (L) of about 1221 mm, and an overall height (H) of about 52 mm.

Each drive module 420 including an endless track 421 supported by drive wheels and driven by at least one motor 422. The endless tracks 421 engage a ground surface and propel the vehicle 400. An upper surface of the endless tracks 421 is positioned below a height of the planar upper surface 411, so that the planar upper surface 411 engages a top deckboard in preference to the endless tracks 421. The planar upper surface 411 includes angled portions 411a at the two ends of the planar upper surface 411. The angled portions 411a are bent toward the endless track 421. When in use, this allows the planar upper surface 411 to guard the endless tracks 421 from engaging with the top deckboard of a pallet when the inspection vehicle 400 is tilted in the confined space. The angled portions 411a allows the inspection vehicle 400 to tilt at a greater degree. Additionally, front ones of the endless tracks 421 project forwardly of the body 410, so that the front endless tracks engage a side surface in preference to the body 110.

The inspection vehicle 400 further includes a plurality of sensors 430, a communications module 440 and a processing device 450. There is a front sensor 430a and a rear sensor 430b disposed at the ends of the inspection vehicle 400, and a plurality of side sensors 430c are disposed on the sides of the inspection vehicle 400. The front and rear sensors 430a, 430b are image sensors, and the side sensors 430c are thermal image sensors and range sensors. The communications module 440 provides sensor data to a remote processing system, and receives control signals from the remote processing systems. The one or more processing devices 450 controls the drive modules 420 in accordance with the control signals to allow the inspection vehicle 400 to traverse the confined space.

The drive modules 420 are removably attached to the body 410 via fasteners 423, such as screws. This allows the drive modules 420 to be easily replaced without dismantling the entire inspection vehicle 400. Furthermore, the inspection vehicle 400 are an assembly of three sub-sections and two intermediate sections 480 are used to couple the sub-sections. It should be appreciated that more sub-sections may be coupled to meet a length requirement. The modularity of the inspection vehicle 400 allows the servicing and repairing of parts to be more efficient.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” or “about” means ±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. An inspection vehicle configured to inspect a confined space, the inspection vehicle including:
a) an elongate substantially rigid body including a substantially planar upper surface;
b) a number of drive modules positioned along either side of the body, each drive module including an endless track supported by drive wheels and driven by at least one motor, the endless tracks being configured to engage a surface and propel the vehicle, and wherein:
i) an upper surface of the endless tracks is positioned below a height of the planar upper surface so that the planar upper surface engages an obstacle in preference to the endless tracks;
ii) front ones of the endless tracks project forwardly of the body so that the front endless tracks engage an obstacle in preference to the body;
c) a plurality of sensors disposed around the inspection vehicle to sense the confined space;
d) a communications module configured to:
i) provide sensor data to one or more remote processing systems; and,
ii) receive control signals one or more remote processing systems;
e) one or more processing devices configured to control the drive modules in accordance with the control signals to allow the inspection vehicle to traverse the confined space.

2. An inspection vehicle according to claim 1, wherein the inspection vehicle includes a communications tether that interconnects the communications module and the one or more remote processing systems.

3. An inspection vehicle according to claim 2, wherein the tether is used to provide power to the inspection vehicle.

4. An inspection vehicle according to claim 2, wherein the tether is configured to resist tensional forces, and thereby allowing the inspection vehicle to be retrieved by pulling on the tether.

5. An inspection vehicle according claim 1, wherein the sensors include at least one of:
a) image sensors;
b) thermal image sensors; and,
c) range sensors.

6. An inspection vehicle according to claim 1, wherein the sensors include:
a) a front sensor position on a front of the body;
b) a rear sensor position on a rear of the body; and,
c) side sensors positioned on each side of the body.

7. An inspection vehicle according to claim 1, wherein the one or more processing devices are configured to:
a) at least partially process signals from the sensor; and,
b) generate the sensor data.

8. An inspection vehicle according to claim 1, wherein the one or more remote processing systems are configured to:
a) display a representation of the confined space using the sensor data; and,
b) generate control signals in accordance with user input commands provided at least in part based on the representation.

9. An inspection vehicle according to claim 8, wherein the one or more remote processing systems are configured to:
a) use the sensor data to construct a model of the confined space; and,
b) generate a representation of the model.

10. An inspection vehicle according to claim 1, wherein the vehicle has at least one of:
a) an overall width of about 150 mm;
b) an overall length of about 1220 mm; and,
c) an overall height of about 50 mm.

11. An inspection vehicle according to claim 1, wherein the confined space includes a space between upper and bottom deckboards of a pallet.

12. An inspection vehicle according to claim 11, wherein the vehicle is configured to span a gap between at least one of:
a) bottom deckboards of a pallet; and,
b) adjacent pallets.
